(19) United States
(12) Patent Application Publication
(10) Pub. No.: US 2020/0288801 A1
(43) Pub. Date: Sep. 17, 2020

(54) FIBER BUNDLE FOR ARTIFICIAL HAIR

(71) Applicant: DENKA COMPANY LIMITED, Chuo-ku, Tokyo (JP)

(72) Inventors: Takashi Muraoka, Kamakura-city, Kanagawa (JP); Atsushi Horihata, Kamakura-city, Kanagawa (JP); Atsushi Takei, Kamakura-city Kanagawa (JP)

(73) Assignee: DENKA COMPANY LIMITED, Chuo-ku, Tokyo (JP)

(21) Appl. No.: 16/765,789

(22) PCT Filed: Mar. 1, 2019
(86) PCT No.: PCT/JP2019/008225

§ 371 Date: May 20, 2020

(30) Foreign Application Priority Data
Mar. 6, 2018 (JP) 2018-039435

(51) Int. Cl. A41G 3/00; C08K 5/523; C08K 3/11; A41G 5/00; D01F 6/90; D01F 6/92; D02G 3/44

(52) U.S. Cl. CPC A41G 3/0083; C08K 5/523; C08K 3/11; D02G 3/443; D01F 6/90; D01F 6/92; A41G 5/004

(57) ABSTRACT

A fiber bundle for artificial hair that has good curl setting characteristics, good combing property, tactile sensation and glossiness similar to human hair, and flame retardancy is provided. According to the present invention, provided is a fiber bundle for artificial hair is comprising 20 to 90 parts by mass of a polyester fiber and 10 to 80 parts by mass of a polyamide fiber, wherein the polyester fiber contains a polyester resin (A), a flame retardant (C1) and an auxiliary flame retardant (D1), and the polyamide fiber contains a polyamide resin (B), a flame retardant (C2) and an auxiliary flame retardant (D2).

### TECHNICAL FIELD

The present invention relates to a fiber bundle used for artificial hair, such as wigs, hairpieces, and hair extensions, allowed to be put on and off of the head (hereinafter, simply referred to as “a fiber bundle for artificial hair”).

### BACKGROUND ART

As materials making up fibers for artificial hair, vinyl chloride resins have been widely used because of its excellent processability and the like at low cost (Patent Literature 1).

In order to provide heat resistance to heat from a curling iron, polyester-based fibers for artificial hair, which are highly heat resistant, are under development. A flame retardant polyester fiber comprising a resin composition containing a polyester resin, a flame retardant and an antimony compound are known (Patent Literature 2).

### CITATION LIST

### Patent Literature

Patent Literature 1: JP2004-156149

Patent Literature 2: JP2006-144211

### SUMMARY OF INVENTION

### Technical Problem

Flame retardants are generally added in order to provide flame retardancy to polyester resins. However, due to the low compatibility between polyester resins and flame retardants (especially brominated-based flame retardants), flame retardants are not sufficiently dispersed in polyester resins when melt kneading, and the obtained fiber bundles for hair have poor combing property.

The present invention has been made in view of such circumstances, and an object of the present invention is to provide a fiber bundle for artificial hair having good combing property, tactile sensation and glossiness similar to human hair, and being excellent in curl setting characteristics and flame retardancy.

### Solution to Problem

The present invention employs the following means in order to solve the above problems.
(1) A fiber bundle for artificial hair comprising 20 to 90 parts by mass of a polyester fiber and 10 to 80 parts by mass of a polyamide fiber, wherein the polyester fiber contains a polyester resin (A), a flame retardant (C1) and an auxiliary flame retardant (D1), and the polyamide fiber contains a polyamide resin (B), a flame retardant (C2) and an auxiliary flame retardant (D2).
(2) The fiber bundle for artificial hair of (1), wherein The polyamide fiber contains 3 to 30 parts by mass of the flame retardant (C2) and 0.3 to 10 parts by mass of the auxiliary flame retardant (D2) based on 100 parts by mass of the polyamide resin (B).
(3) The fiber bundle for artificial hair of (1) or (2), wherein the polyester fiber contains 3 to 30 parts by mass of the flame retardant (C1) and 0.3 to 10 parts by mass of the auxiliary flame retardant (D1) based on 100 parts by mass of the polyester resin (A).
(4) The fiber bundle for artificial hair of any one of (1) to (3), wherein the polyamide resin (B) has a weight average molecular weight Mw of 65,000 to 150,000.
(5) The fiber bundle for artificial hair of any one of (1) to (4), wherein the polyamide resin (B) is at least one selected from the group consisting of polyamide 6 and polyamide 66.
(6) The fiber bundle for artificial hair of any one of (1) to (5), wherein the flame retardant (C1) of the polyester fiber and the flame retardant (C2) of the polyamide fiber are brominated-based flame retardants.
(7) The fiber bundle for artificial hair of (6), wherein each of the brominated-based flame retardant is at least one selected from the group consisting of a brominated phenol condensate, a brominated polystyrene-based flame retardant, a brominated benzyl acrylate-based flame retardant, a brominated epoxy-based flame retardant, a brominated phenoxy-based flame retardant, a brominated polycarbonate-based flame retardant and a bromine-containing triazine-based compound.
(8) The fiber bundle for artificial hair of any one of (1) to (7), wherein the auxiliary flame retardant (D2) of the polyamide fiber is at least one selected from the group consisting of antimony trioxide, antimony tetroxide, antimony pentoxide, sodium antimonate, zinc borate, and zinc stannate.
(9) The fiber bundle for artificial hair of any one of (1) to (8), wherein the auxiliary flame retardant (D2) of the polyamide fiber has an average particle size of 1 to 10 μm.
(10) The fiber bundle for artificial hair of any one of (1) to (9), the polyester resin (A) has a melt viscosity of 80 to 300 Pa·s.
(11) The fiber bundle for artificial hair of any one of (1) to (10), a resin composition constituting the polyamide fiber has a melt viscosity of 20 to 200 Pa·s

### Effect of the Invention

According to the present invention, a fiber bundle for artificial hair having good combing property, tactile sensation and glossiness similar to human hair, and being excellent in curl setting characteristics and flame retardancy can be obtained.

### DESCRIPTION OF EMBODIMENTS

Descriptions below are given to embodiments of the present invention.

A fiber bundle for artificial hair of the present invention comprises 20 to 90 parts by mass of a polyester fiber and 10 to 80 parts by mass of a polyamide fiber, wherein the polyester fiber contains a polyester resin (A), a flame retardant (C1) and an auxiliary flame retardant (D1), and the polyamide fiber contains a polyamide resin (B), a flame retardant (C2) and an auxiliary flame retardant (D2). The polyester fiber is a fiber for artificial hair made of a polyester resin and the polyamide fiber is a fiber for artificial hair made of a polyamide resin, respectively.

### <Mass Ratio of Polyester Fiber and Polyamide Fiber>

The mass ratio of the polyester fiber is 20 to 90 parts by mass, preferably 30 to 70 parts by mass, and more preferably 40 to 60 parts by mass. If the content of the polyester fiber is less than 20 parts by mass, curl setting characteristics may deteriorate. If the content of the polyester fiber is more than 90 parts by mass, combing property may deteriorate.

The mass ratio of the polyamide fiber is 10 to 80 parts by mass, preferably 30 to 70 parts by mass, and more preferably 40 to 60 parts by mass. If the content of the polyamide fiber is less than 10 parts by mass, curl combing property may deteriorate. If the content of the polyamide fiber is more than 80 parts by mass, curl setting characteristics may deteriorate.

The fiber bundle for artificial hair of the present embodiment may comprise only the polyester fiber and the polyamide fiber or may further comprise a fiber other than these.

### <Polyester Fiber>

The polyester fiber preferably contains 3 to 30 parts by mass of the flame retardant (C1) and 0.3 to 10 parts by mass of the auxiliary flame retardant (D1) based on 100 parts by mass of the polyester resin (A). If the content of the flame retardant (C1) is less than 3 parts by mass, flame retardancy may deteriorate. If the content of the flame retardant (C1) is more than 30 parts by mass, tactile sensation and combing property may deteriorate. The content of the auxiliary flame retardant (D1) is preferably 0.3 to 10 parts by mass, and more preferably 1 to 5 parts by mass. If the content of the auxiliary flame retardant is less than 0.3 parts by mass, the effect of improving flame retardancy cannot be obtained. If the content of the auxiliary flame retardant is more than 10 parts by mass, tactile sensation may deteriorate.

### <Polyester Resin (A)>

The polyester resin used in the present invention is not particularly limited, and includes, for example, polyethylene terephthalate, polybutylene terephthalate, polytrimethylene terephthalate and/or a copolymerized polyester resin, which contains these polyalkylene terephthalates as a main component (“as a main component” means containing 80 mol % or more of these polyalkylene terephthalates) and a small amount of copolymerization component. Polyethylene terephthalate, polytrimethylene terephthalate, and polybutylene terephthalate are particularly preferable in terms of tactile sensation of fibers, availability, and cost.

The copolymerization component includes, for example, isophthalic acid, orthophthalic acid, naphthalenedicarboxylic acid, paraphenylenedicarboxylic acid, trimellitic acid, pyromellitic acid, succinic acid, glutaric acid, adipic acid, speric acid, azelaic acid, sebacine acid, polyvalent carboxylic acid such as dodecanedioic acid, their derivatives, dicarboxylic acid including sulfonic acid salt such as 5-sodium sulfoisophthalic acid, dihydroxyethyl 5-sodium sulfoisophthalate, their derivatives, 1,2-propanediol , 1,3-propanediol, 1,4-butanediol, 1,6-hexanediol, neopentyl glycol, 1,4-cyclohexanedimethanol, diethylene glycol, polyethylene glycol, trimethylolpropane, pentaerythritol, 4-hydroxybenzoic acid, s- caprolactone and the like.

The copolymerized polyester resin is typically produced by reacting a polymer of terephthalic acid and/or its derivative (for example, methyl terephthalate) as a main component and an alkylene glycol with a small amount of a copolymerization component. This production method is preferable in terms of stability and ease of operation. It may be produced by polymerizing a mixture of terephthalic acid and/or its derivative (for example, methyl terephthalate) as a main component and alkylene glycol, and a small amount of a monomer or oligomer component as a copolymerization component.

The polyester resin (A) preferably has a melt viscosity of 80 to 300 Pa·s, more preferably 100 to 250 Pa·s. If the melt viscosity is too low, the shear force is not sufficient, which leads to poor dispersibility of the flame retardant and poor combing property. If the melt viscosity is too high, the difference in viscosity between the polyester resin (A) and the flame retardant becomes large, which leads to poor dispersibility of the flame retardant and poor combing property.

The melt viscosity of the polyester resin (A) is measured using a sample dehumidified and dried so that a moisture absorption of the sample is 100 ppm or less, under the conditions of sample amount 20 cc, set temperature 285° C., piston speed 200 mm/min, capillary length 20 mm, capillary diameter 1 mm. As a measuring device, Capiro Graph 1D manufactured by Toyo Seiki Seisaku-sho, Ltd. can be used.

### <Flame Retardant (C1)>

Examples of the flame retardant (C1) include a bromine-based flame retardant and a phosphorus-based flame retardant.

Examples of the bromine-based flame retardant include brominated polystyrene, ethylene bistetrabromophthalimide, bis (pentabromophenyl) ethane, brominated epoxy, a brominated benzyl acrylate-based flame retardant (for example, poly (pentabromobenzyl acrylate)), brominated phenol, polydibromophenylene oxide and brominated phenoxy. One of these may be used alone, or two or more of these may be used in combination.

The phosphorus-based flame retardant is a flame retardant containing phosphorus and includes, for example, a phosphate-based compound, a phosphonate-based compound, a phosphinate-based compound, a phosphine oxide-based compound, a phosphonite-based compound, a phosphinite-based compound, a phosphine-based compound, a phosphinic acid salt and the like. A phosphinic acid salt is preferable because it has excellent heat resistance. One of these may be used alone, or two or more of these may be used in combination.

The content of the flame retardant (C1) is preferably 3 to 30 parts by mass based on 100 parts by mass of the polyester resin (A). If the content of the flame retardant (C1) is less than 3 parts by mass, flame retardancy may deteriorate. If the content of the flame retardant (C1) is more than 30 parts by mass, combing property and tactile sensation may deteriorate.

### <Auxiliary Flame Retardant (D1)>

Examples of the auxiliary flame retardant (D1) preferably include antimony trioxide, antimony tetraoxide, antimony pentoxide, sodium antimonate, zinc borate and zinc stannate. Antimony trioxide and sodium antimonate are particularly preferable in terms of flame retardant and transparent. One of these may be used alone, or two or more of these may be used in combination.

The content of the auxiliary flame retardant (D1) is preferably 0.3 to 10 parts by mass, and more preferably 1 to 5 parts by mass based on 100 parts by mass of the polyester resin (A). If the content of the auxiliary flame retardant (D1) is less than 0.3 parts by mass, flame retardancy may deteriorate. If the content of the auxiliary flame retardant (D1) is more than 10 parts by mass, tactile sensation may deteriorate.

### <Other Additives>

The polyester fiber used in the present embodiment may contain additives such as a heat resistant, a light stabilizer, a fluorescent agent, an antioxidant, a antistatic agent, a pigment, a dye, a plasticizer, a lubricant, and the like, if necessary. By adding a coloring agent such as a pigment or a dye, a pre-colored fiber (so-called spun-dyed fiber) can be obtained.

### <Polyamide Fiber>

The polyamide fiber preferably contains 3 to 30 parts by mass of the flame retardant (C2) and 0.3 to 10 parts by mass of the auxiliary flame retardant (D2) based on 100 parts by mass of the polyamide resin (B),If the content of the flame retardant (C2) is less than 3 parts by mass, flame retardancy may deteriorate. If the content of the flame retardant (C2) is more than30 parts by mass, tactile sensation and combing property may deteriorate. The content of the auxiliary flame retardant (D2) is preferably 0.3 to 10 parts by mass, and more preferably 1 to 5 parts by mass. If the content of the auxiliary flame retardant is less than 0.3 parts by mass, the effect of improving the flame retardancy cannot be obtained. If the content of the auxiliary flame retardant is more than 10 parts by mass, tactile sensation may deteriorate.

The resin composition constituting the polyamide fiber preferably has a melt viscosity of 20 to 200 Pa·s, more preferably 30 to 130 Pa·s, even more preferably 40 to 100 Pa·s. If the melt viscosity is too low, the shear force is not sufficient, which leads to poor dispersibility of the flame retardant and poor combing property. If the melt viscosity is too high, the uniformity of the fiber bundle fineness may be reduced, which leads to poor combing property. The melt viscosity of the resin composition can be adjusted by changing the kind and/or addition amount of the lubricant.

The melt viscosity of the resin composition constituting the polyamide fiber is measured using a sample dehumidified and dried so that a moisture absorption of the sample is 100 ppm or less, under the conditions of sample amount 20 cc, set temperature 300° C., piston speed 200 mm/min, capillary length 20 mm, capillary diameter 1 mm. As a measuring device, Capiro Graph 1D manufactured by Toyo Seiki Seisaku-sho, Ltd. can be used.

### <Polyamide Resin (B)>

The kind of the polyamide resin (B) is not particularly limited. The examples of the polyamide resin include an aliphatic polyamide resin, which is a polyamide resin having no aromatic ring, and includes n-nylon formed by ring-opening polymerization of lactam and n, m-nylon synthesized by copolycondensation reaction of aliphatic diamine and aliphatic dicarboxylic acid. The lactam preferably has 6 to 12 carbon atoms, and more preferably has 6 carbon atoms. the aliphatic diamine and the aliphatic dicarboxylic acid preferably have 6 to 12 carbon atoms, and more preferably 6 carbon atoms, respectively. The aliphatic diamine and the aliphatic dicarboxylic acid preferably have a functional group (an amino group or a carboxyl group) at both ends of the carbon atom chain, but they may have the functional group at a position other than both ends. The carbon atom chain is preferably linear but may have branch. Examples of the aliphatic polyamide resin include, for example, polyamide 6 and polyamide 66. From the viewpoint of heat resistance, polyamide 66 is preferable. Examples of polyamide 6 include CM1007, CM1017, CM1017XL3, CM1017K, CM1026 (these are manufactured by Toray Industries, Inc.), and the like. Examples of the polyamide 66 include CM 3007, CM 3001-N, CM 3006, CM 3301 L (these are manufactured by Toray Industries, Inc.), Zitel 101, 42A (these are manufactured by Du Pont K.K.), Leona 1300S, 1500, 1700 (these are manufactured by Asahi Kasei Chemicals Corp.) and the like.

The polyamide resin may comprise a semi-aromatic polyamide resin having a skeleton obtained by condensation polymerization of an aliphatic diamine and an aromatic dicarboxylic acid. Examples of the semi-aromatic polyamide resin include polyamide 6T, polyamide 9T, polyamide 10T, and modified polyamide 6T, modified polyamide 9T, and modified polyamide 10T (modified ones are obtained by copolymerizing these polyamides and monomers for modifying). Among them, polyamide 10T is preferable from the viewpoint of ease of melt molding. The aliphatic diamine preferably has 6 to 10 carbon atoms, and more preferably has 10 carbon atoms. The aliphatic diamine preferably has an amino group at both ends of the carbon atom chain, but it may have the amino group at a position other than both ends. The carbon atom chain is preferably linear but may have branch. Examples of the aromatic dicarboxylic acid include phthalic acid, isophthalic acid, terephthalic acid and the like. Among them, terephthalic acid is most preferable.

Examples of the polyamide 6T and its modified polymer include VESTAMID HP Plus M1000 manufactured by Evonik and ARLEN manufactured by Mitsui Chemicals, Inc. Examples of the polyamide 9T and its modified polymer include Genestar manufactured by Kuraray Co., Ltd. Examples of polyamide 10 T and its modified polymer include VESTAMID HO Plus M 3000 manufactured by Evonik and Grivory manufactured by EMS-CHEMIE.

The mixing ratio of the aliphatic polyamide and the semi-aromatic polyamide is preferably in a range of “50 parts by mass/50 parts by mass” to “99 parts by mass/1 part by mass”, more preferably in a range of “70 parts by mass/30 parts by mass” to “90 parts by mass/10 parts by mass”. If the proportion of semi-aromatic polyamide resin is less than the above range, the effect of improving productivity by adding semi-aromatic polyamide resin may be reduced. Also, as mentioned above, the fiber for artificial hair made of aliphatic polyamide resin has a good tactile sensation similar to human hair, but if the proportion of semi-aromatic polyamide resin is higher than the above range, tactile sensation may deteriorate.

The weight average molecular weight (Mw) of the polyamide resin is, for example, 65,000 to 150,000. If the Mw is 65,000 or more, the drip resistance becomes good and the flame retardancy is improved. On the other hand, if the Mw exceeds 150,000, the melt viscosity of the material increases, the yarn breaks during the drawing step, and processability deteriorates. Therefore, the Mw is preferably 150,000 or less. From the viewpoint of the balance of flame retardancy and processability, Mw is more preferably 70,000 to 120,000.

### <Flame Retardant (C2)>

Examples of the flame retardant (C2) include a bromine-based flame retardant and a phosphorus-based flame retardant. The flame retardant (C2) may be the same compound as the flame retardant (C1) or may be a different compound.

Examples of the bromine-based flame retardant include a brominated phenol condensate, a brominated polystyrene-based flame retardant, a brominated benzyl acrylate-based flame retardant, a brominated epoxy-based flame retardant, a brominated phenoxy-based flame retardant, a brominated polycarbonate-based flame retardant and a bromine-containing triazine-based compound. One of these may be used alone, or two or more of these may be used in combination.

The phosphorus-based flame retardant is a flame retardant containing phosphorus and includes, for example, a phosphate-based compound, a phosphonate-based compound, a phosphinate-based compound, a phosphine oxide-based compound, a phosphonite-based compound, a phosphinite-based compound, a phosphine-based compound, a phosphinic acid salt and the like. A phosphinic acid salt is preferable because it has excellent heat resistance. One of these may be used alone, or two or more of these may be used in combination.

The content of the flame retardant (C2) is preferably 3 to 30 parts by mass based on 100 parts by mass of the polyamide resin (B). If the content of the flame retardant (C2) is less than 3 parts by mass, flame retardancy may deteriorate. If the content of the flame retardant (C2) is more than 30 parts by mass, combing property and tactile sensation may deteriorate.

### <Auxiliary Flame Retardant (D2)>

The auxiliary flame retardant (D2) preferably includes antimony trioxide, antimony tetraoxide, antimony pentoxide, sodium antimonate, zinc borate and zinc stannate. Antimony trioxide and sodium antimonate are particularly preferable in terms of flame retardant and transparent. One of these may be used alone, or two or more of these may be used in combination. The auxiliary flame retardant (D2) may be the same compound as the auxiliary flame retardant (D1) or may be a different compound.

The content of the auxiliary flame retardant (D2) is preferably 0.3 to 10 parts by mass, and more preferably 1 to 5 parts by mass based on 100 parts by mass of the polyamide resin (B). If the content of the auxiliary flame retardant (D2) is less than 0.3 parts by mass, flame retardancy may deteriorate. If the content of the auxiliary flame retardant (D2) is more than 10 parts by mass, tactile sensation may deteriorate.

The auxiliary flame retardant (D2) of the polyamide fiber preferably has an average particle size ranging of 1 to 10 μm. If the average particle size is less than 1 μm, the particles easily aggregate and are difficult to disperse uniformly, which may cause non-uniformity in flame retardancy. If the average particle size exceeds 10 μm, the yarn easily breaks from these particles as starting points and processability may deteriorate. The “average particle size” herein means a particle size with an integrated value of 50% in the particle size distribution obtained by laser diffraction scattering.

### <Other Additives>

The polyamide fiber used in the present embodiment may contain additives such as a heat resistant, a light stabilizer, a fluorescent agent, an antioxidant, a antistatic agent, a pigment, a dye, a plasticizer, a lubricant, and the like, if necessary. By adding a coloring agent such as a pigment or a dye, a pre-colored fiber (so-called spun-dyed fiber) can be obtained.

### <Production Process>

Descriptions are given below to an example of production process of the polyester fiber and the polyamide fiber, which does not limit the present invention.

The polyester fiber of one embodiment according to the present invention can be produced by dry blending the polyester resin (A), the flame retardant (C1), and the auxiliary flame retardant (D1), then melt-kneading with a general kneader and melt-spinning with a normal melt-spinning method.

Similarly, the polyamide fiber can be produced by dry blending the polyamide resin (B), the flame retardant (C2), and the auxiliary flame retardant (D2), then melt-kneading with a general kneader and melt-spinning with a normal melt-spinning method.

Examples of the device for melt kneading include a single screw extruder, a twin screw extruder, a roll, a banbury mixer, a kneader and the like. Among them, a twin-screw extruder is preferable from the viewpoint of adjustment of kneading degree and ease of operation.

For melt spinning, a spinning nozzle with nozzle holes in a special shape, not only in a simple circular shape, may be used to produce artificial hair fiber with a cross section in a deformed shape, such as an oval shape, a Y shape, an H shape, an X shape, and a flower shape.

The obtained undrawn yarn is drawn to improve the tensile strength of the fiber. The drawing may be performed by a two-step method in which the undrawn yarn is once wound on a bobbin and then drawn in another step different from the melt spinning step, or a direct spinning drawing method in which continuous drawing is carried out from the melt spinning step without winding on a bobbin. The drawing is performed by single-stage drawing to draw to the target draw ratio at a time or multi-stage drawing to draw to the target draw ratio in drawing at two or more times. A heating mechanism in a case of hot drawing may be a heating roller, a heating plate, a steam jet apparatus, a hot water tank, and the like, and they may be used in combination as appropriate.

The polyester fiber and the polyamide fiber in the present embodiment preferably have fineness from 10 to 150 dtex, more preferably from 30 to 150 dtex, and even more preferably from 35 to 120 dtex.

### EXAMPLES

Then, the present invention is described more specifically based on Examples and Comparative Examples, which do not limit the present invention.

Polyester fibers and polyamide fibers were mixed and hackled to obtain fiber bundles for artificial hair having a mass ratio shown in Tables 1 to 3.

By dehumidifying and drying, polyester resins (A) having a moisture absorption of 100 ppm or less were prepared. The polyester resins (A), flame retardants (C1), and auxiliary flame retardants (D1) were blended to obtain blended materials having the mass ratios of Examples and Comparative Examples in Tables 1 to 3. The blended materials were kneaded using a φ26 mm twin screw extruder to obtain raw material pellets for spinning.

Then, the pellets were dehumidified and dried so that a moisture absorption of the pellets was 100 ppm or less. Thereafter, they were spun using a φ40 mm single-axis melt spinning machine. In the spinning, the molten resin discharged from a die having 100 holes with a hole diameter of 0.5 mm was cooled through a water bath at about 30° C. while adjusting the discharge amount and the winding speed. Thereby, an undrawn yarn was produced. The set temperature of the φ40 mm melt spinning machine was appropriately adjusted according to the addition amounts of the polyester resin (A), the flame retardant (C1) and the auxiliary flame retardant(D1).

The undrawn fiber obtained was drawn at 100° C. and was then subjected to annealing at 150 to 200° C. Thereby polyester fibers were obtained. The drawing magnification was 3 times, and the relaxing rate during annealing was 0.5 to 3%. The relaxing rate during annealing is a value calculated by (rotation speed of winding roller during annealing)/(rotation speed of feeding roller during annealing).

By dehumidifying and drying, the polyamide resin (B) having moisture absorption of 1000 ppm or less was prepared. The polyamide resin (B), the flame retardant (C2), the flame retardant auxiliary (D2) and lubricant were blended to obtain blended materials having the mass ratios of Examples and Comparative Examples in Tables 1 to 3. The lubricant was added so that the melt viscosity became the value shown in Tables 1 to 3. The blended materials were kneaded using a φ26 mm twin screw extruder to obtain raw material pellets for spinning.

Then, the pellets were dehumidified and dried so that a water content rate of the pellets was 1000 ppm or less. Thereafter, polyamide fibers were obtained by the same production method as the polyester fibers.

The materials in Tables 1 to 3, the followings were employed. Polyester Resin (A)
Polyethylene terephthalate (melt viscosity of 145Pa·s): J125S produced by Mitsui Chemicals, Inc.
Polyethylene terephthalate (melt viscosity of 70 Pa·s): product of the applicant
Polyethylene terephthalate (melt viscosity of 90 Pa·s): product of the applicant
Polyethylene terephthalate (melt viscosity of 260 Pa·s): product of the applicant
Polyethylene terephthalate (melt viscosity of 310 Pa·s): product of the applicant
Polyamide Resin (B)
Polyamide 66 (weight average molecular weight of 50000): AMILAN CM3001-N produced by Toray Industries, Inc.
Polyamide 66 (weight average molecular weight of 65000): LEONA 1500 produced by Asahi Kasei Chemicals Corp.
Polyamide 66 (weight average molecular weight of 90000): Zytel 42A produced by Du Pont K.K.
Polyamide 66 (weight average molecular weight of 120000): product of the applicant

Flame Retardant (C1)

Brominated benzil acrylate-based flame retardant: FR-1025 produced by ICL-IP Ltd. Phosphorus containing flame retardant: PX-200 produced by Daihachi Chemical Industry Co., Ltd.

Flame Retardant (C2)

Brominated epoxy resin: SRT-20000 produced by Sakamoto Yakuhin Kogyo Co., Ltd. Brominated polystyrene resin: HP-7020 produced by Albemarle Corp.

Brominated phenoxy resin: YPB-43C produced by DKS Co., Ltd.

Phosphorus containing flame retardant: PX-200 produced by Daihachi Chemical Industry Co., Ltd.

Auxiliary Flame Retardant (D1)

Sodium antimonite (average particle size of 4 μm): SA-A produced by Nihon Seiko Co., Ltd.

Auxiliary Flame Retardant (D2)

Antimony trioxide (average particle size of 0.5 μm): PATOX-M produced by Nihon Seiko Co., Ltd.

Antimony trioxide (average particle size of 3 μm): PATOX-P produced by Nihon Seiko Co., Ltd.

Antimony trioxide (average particle size of 12 μm): Z produced by Campnine NV

Sodium antimonite (average particle size of 4 μm): SA-A produced by Nihon Seiko Co., Ltd

<Weight Average Molecular Weight: Mw>

In Tables 1 to 3, the weight average molecular weight Mw was measured under the following equipment and conditions.

Equipment used: [Pump] shodex DS-4
[Column] shodex GPC HFIP-806M x 2 +HFIP-803
[Detector] shodex RI-71

Eluent: hexafluoroisopropanol (+additive CF₃COONa (5 mmol/L))

Pretreatment: Filtration through a membrane filter—(0.2 μm)

Concentration: 0.2 w/v %

Injection volume: 100 μL

Column temperature: 40° C.

Flow rate: 1.0 ml/min.

Standard substance: standard polymethyl methacrylate (PMMA) (The calibration curve was prepared by standard PMMA, and the weight average molecular weight was expressed as PMMA equivalent value.)

Various evaluations of the fiber bundle for artificial hair obtained in each of Examples and Comparative Examples were performed according to the following methods. The results are shown in Tables 1 to 3.

### <Curl Setting Characteristics>

A fiber bundle for artificial hair having 50 cm of a length and 2 g of a weight was prepared for the evaluation of curl setting characteristics. The fiber bundle was curled by winding it around a 180° C. iron made of iron (iron diameter 1.4 cm) and holding for 10 seconds, then it was removed from the iron. The fiber bundle was fixed at one end, suspended and stored at a temperature of 23° C. and a humidity of 50% for 24 hours. It was evaluated by dividing the distance from the root to the tip by the total length (50 cm), according to the following evaluation criteria.

A: The distance after curling is less than 0.75 with respect to the total length before the curling

B: The distance after curling is 0.75 or more and less than 0.85 with respect to the total length before the curling

D: The distance after curling is 0.85 or more with respect to the total length before the curling

### <Combing Property>

In each of the Examples and Comparative Examples, a fiber bundle for artificial hair having 300 mm of a length and 2 g of a weight was prepared. Combing property was evaluated based on the following evaluation criteria for resistance and tangling of the fibers when the fiber bundle was combed through.

A: There is no resistance, and fibers do not tangle

B: There is a little resistance, but fibers do not tangle

C: There is some resistance, and fibers rarely tangle

D: There is resistance, or fibers frequently tangle

### <Tactile Sensation>

In each of the Examples and Comparative Examples, a fiber bundle for artificial hair having 250 mm of a length and 20 g of a weight was prepared. Tactile sensation was evaluated based on hand touch by 10 technicians in the field of processing a fiber for artificial hair (work experience of 5 years or more), according to the following evaluation criteria.

A: nine or more technicians evaluated that tactile impression was good.

B: Seven or eight technicians evaluated that tactile impression was good.

D: Six or fewer technicians evaluated that the tactile impression was good.

### <Glossiness>

In each of the Examples and Comparative Examples, a fiber bundle for artificial hair having 250 mm of a length and 20 g of a weight was prepared. The glossiness was visually observed under sunlight by a technician in the field of processing a fiber for artificial hair (work experience of 5 years or more), compared with the glossiness of human hair, and evaluated according to the following evaluation criteria.

A: Glossiness similar to human hair

B: Glossiness not the same as but roughly close to human hair

D: Glossiness significantly different from human hair

<Flame Retardancy>

In each of the Examples and Comparative Examples, a fiber bundle for artificial hair having 300 mm of a length and 2 g of a weight was prepared. The fiber bundle was fixed at the one end and suspended vertically. The flame retardancy was evaluated by measuring fire spreading time after the lower end of the fiber bundle being made to contact with a flame of 20 mm in length for 5 seconds and keeping away from the flame, according to the following evaluation criteria. The result is based on the average value of the results measured 10 times.

A: Fire spreading time is less than 1 second

B: Fire spreading time is 1 second or more and less than 4 seconds

C: Fire spreading time is 4 seconds or more and less than 7 seconds

D: Fire spreading time is 7 seconds or more

TABLE 1

| | | | Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Polyester Fiber/Polyamide Fiber (Mass Ratio) | | | 50/50 | 20/80 | 90/10 | 50/50 | 50/50 | 50/50 | 50/50 | 50/50 | 50/50 | 50/50 | 50/50 |
| Polyester | Polyester Resin (A) | 145 Pa · s | 100 | 100 | 100 | 100 | 100 | 100 | 100 | 100 | 100 | 100 | 100 |
| Fiber | Flame Retardant | Brominated benzil | 15 | 15 | 15 | 15 | 15 | 15 | 15 | 3 | 30 | 15 | 15 |
| | (C 1) | acrylate-based | | | | | | | | | | | |
| | | flame retardant | | | | | | | | | | | |
| | Auxiliary | Sodium antimonite | 1 | 1 | 1 | 1 | 1 | 1 | 1 | 1 | 1 | 0.3 | 10 |
| | Flame Retardant | (4 μm) | | | | | | | | | | | |
| | (D 1) | | | | | | | | | | | | |
| Polyamide | Polyamide Resin (B) | Mw65000 | 100 | 100 | 100 | 100 | 100 | 100 | 100 | 100 | 100 | 100 | 100 |
| Fiber | Flame Retardant | Brominated | 15 | 15 | 15 | 3 | 30 | 15 | 15 | 15 | 15 | 15 | 15 |
| | (C 2) | epoxy resin | | | | | | | | | | | |
| | Auxiliary | Sodium antimonite | 1 | 1 | 1 | 1 | 1 | 0.3 | 10 | 1 | 1 | 1 | 1 |
| | Flame Retardant | (4 μm) | | | | | | | | | | | |
| | (D 2) | | | | | | | | | | | | |

| | | | | | | | | | | | |
|---|---|---|---|---|---|---|---|---|---|---|---|
| Melt Viscosity Pa · s | 57 | 57 | 57 | 64 | 44 | 54 | 62 | 57 | 57 | 57 | 57 |

| | | | | | | | | | | | |
|---|---|---|---|---|---|---|---|---|---|---|---|
| Curl Setting Characteristics | A | B | A | A | A | A | A | A | A | A | A |
| Combing Property | A | A | B | A | B | A | A | A | B | A | A |
| Tactile Sensation | A | A | A | A | B | A | B | A | B | A | B |
| Glossiness | A | A | A | A | A | A | A | A | A | A | A |
| Flame Retardancy | B | B | B | C | B | C | B | C | B | C | B |

TABLE 2

| | | | Example | | | | | | | |
|---|---|---|---|---|---|---|---|---|---|---|
| | | | 12 | 13 | 14 | 15 | 16 | 17 | 18 | 19 |
| Polyester Fiber/Polyamide Fiber | | | 50/50 | 50/50 | 50/50 | 50/50 | 50/50 | 50/50 | 50/50 | 50/50 |
| (Mass Ratio) | | | | | | | | | | |
| Polyester | Polyester | 145 Pa · s | 100 | 100 | 100 | 100 | 100 | 100 | 100 | 100 |
| Fiber | Resin | 70 Pa · s | | | | | | | | |
| | (A) | 90 Pa · s | | | | | | | | |
| | | 260 Pa · s | | | | | | | | |
| | | 310 Pa · s | | | | | | | | |
| | Flame Retardant | Brominated benzil | 15 | 15 | 15 | 15 | 15 | 15 | 15 | 15 |
| | (C 1) | acrylate-based | | | | | | | | |
| | | flame retardant | | | | | | | | |
| | | Phosphorus containing | | | | | | | | |
| | | flame retardant | | | | | | | | |
| | Auxiliary | Sodium | 1 | 1 | 1 | 1 | 1 | 1 | 1 | 1 |
| | Flame Retardant | antimonite | | | | | | | | |
| | (D 1) | (4 μm) | | | | | | | | |
| Polyamide | Polyamide | MW120000 | 100 | | | | | | | |
| Fiber | Resin | Mw90000 | | 100 | | | | | | |
| | (B) | Mw65000 | | | | 100 | 100 | 100 | 100 | 100 |
| | | Mw50000 | | | 100 | | | | | |
| | Flame Retardant | Brominated | 15 | 15 | 15 | | | 15 | 15 | 15 |
| | (C 2) | epoxy resin | | | | | | | | |
| | | Brominated | | | | 15 | | | | |
| | | polystyrene resin | | | | | | | | |
| | | Brominated | | | | | 15 | | | |
| | | phenoxy resin | | | | | | | | |
| | | Phosphorus containing | | | | | | | | |
| | | flame retardant | | | | | | | | |
| | Auxiliary | Antimony trioxide | | | | | | 1 | | |
| | Flame Retardant | (0.5 μm) | | | | | | | | |
| | (D 2) | Antimony trioxide | | | | | | | 1 | |
| | | (3 μm) | | | | | | | | |
| | | Antimony trioxide | | | | | | | | 1 |
| | | (12 μm) | | | | | | | | |
| | | Sodium antimonite | 1 | 1 | 1 | 1 | 1 | | | |
| | | (4 μm) | | | | | | | | |
| | Melt Viscosity Pa · s | | 128 | 67 | 47 | 62 | 48 | 56 | 58 | 56 |
| Curl Setting Characteristics | | | A | A | A | A | A | A | A | A |
| Combing Property | | | B | A | A | A | A | A | A | A |
| Tactile Sensation | | | A | A | A | A | A | A | A | A |
| Glossiness | | | A | A | A | A | A | A | A | A |
| Flame Retardancy | | | B | A | C | B | B | C | B | B |
| | | | Example | | | | | | | |
| | | | 20 | 21 | 22 | 23 | 24 | 25 | 26 | 27 |
| Polyester Fiber/Polyamide Fiber | | | 50/50 | 50/50 | 50/50 | 50/50 | 50/50 | 50/50 | 50/50 | 50/50 |
| (Mass Ratio) | | | | | | | | | | |
| Polyester | Polyester | 145 Pa · s | | | | | 100 | 100 | 100 | 100 |
| Fiber | Resin | | | | | | | | | |
| | (A) | 70 Pa · s | 100 | | | | | | | |
| | | 90 Pa · s | | 100 | | | | | | |
| | | 260 Pa · s | | | 100 | | | | | |
| | | 310 Pa · s | | | | 100 | | | | |
| | Flame Retardant | Brominated benzil | 15 | 15 | 15 | 15 | 15 | 15 | 15 | |
| | (C 1) | acrylate-based | | | | | | | | |
| | | flame retardant | | | | | | | | |
| | | Phosphorus containing | | | | | | | | 15 |
| | | flame retardant | | | | | | | | |
| | Auxiliary | Sodium antimonite | 1 | 1 | 1 | 1 | 1 | 1 | 1 | 1 |
| | Flame Retardant | (4 μm) | | | | | | | | |
| | (D1) | | | | | | | | | |
| Polyamide | Polyamide | MW120000 | | | | | | | | |
| Fiber | Resin | Mw90000 | | | | | | 100 | 100 | |
| | (B) | Mw65000 | 100 | 100 | 100 | 100 | 100 | | | 100 |
| | | Mw50000 | | | | | | | | |
| | Flame Retardant | Brominated | 15 | 15 | 15 | 15 | | 15 | 15 | 15 |
| | (C 2) | epoxy resin | | | | | | | | |
| | | Brominated | | | | | | | | |
| | | polystyrene resin | | | | | | | | |
| | | Brominated | | | | | | | | |
| | | phenoxy resin | | | | | | | | |
| | | Phosphorus | | | | | 15 | | | |
| | | containing | | | | | | | | |
| | | flame retardant | | | | | | | | |
| | Auxiliary | Antimony trioxide | | | | | | | | |
| | Flame Retardant | (0.5 μm) | | | | | | | | |
| | (D 2) | Antimony trioxide | | | | | | | | |
| | | (3 μm) | | | | | | | | |
| | | Antimony trioxide | | | | | | | | |
| | | (12 μm) | | | | | | | | |
| | | Sodium antimonite | 1 | 1 | 1 | 1 | | 1 | 1 | 1 |
| | | (4 μm) | | | | | | | | |

| | | | | | | | | |
|---|---|---|---|---|---|---|---|---|
| Melt Viscosity Pa · s | 59 | 56 | 57 | 56 | 52 | 110 | 143 | 58 |

| | | | | | | | | |
|---|---|---|---|---|---|---|---|---|
| Curl Setting Characteristics | A | A | A | A | A | A | A | A |
| Combing Property | C | B | B | C | A | B | C | A |
| Tactile Sensation | A | A | A | A | A | A | A | A |
| Glossiness | A | A | A | A | B | A | A | B |
| Flame Retardancy | B | B | B | B | C | A | B | C |

TABLE 3

| | | | Comparative Example | | | | | |
|---|---|---|---|---|---|---|---|---|
| | | | 1 | 2 | 3 | 4 | 5 | 6 |
| Polyester Fiber/Polyamide Fiber (Mass Ratio) | | | 19/81 | 91/9 | 50/50 | 50/50 | 50/50 | 50/50 |
| Polyester | Polyester Resin | 145 Pa · s | 100 | 100 | 100 | 100 | 100 | 100 |
| Fiber | (A) | | | | | | | |
| | Flame Retardant | Brominated benzil | 15 | 15 | 0 | 15 | 15 | 15 |
| | (C 1) | acrylate-based | | | | | | |
| | | flame retardant | | | | | | |
| | Auxiliary | Sodium antimonite | 1 | 1 | 1 | 0 | 1 | 1 |
| | Flame Retardant | (4 μm) | | | | | | |
| | (D 1) | | | | | | | |
| Polyamide | Polyamide Resin | Mw65000 | 100 | 100 | 100 | 100 | 100 | 100 |
| Fiber | (B) | | | | | | | |
| | Flame Retardant | Brominated | 15 | 15 | 15 | 15 | 0 | 15 |
| | (C 2) | epoxy resin | | | | | | |
| | Auxiliary | Sodium antimonite | 1 | 1 | 1 | 1 | 1 | 0 |
| | Flame Retardant | (4 μm) | | | | | | |
| | (D 2) | | | | | | | |

| | | | | | | |
|---|---|---|---|---|---|---|
| Melt Viscosity Pa · s | 57 | 57 | 57 | 57 | 65 | 56 |

| | | | | | | |
|---|---|---|---|---|---|---|
| Combing Property | A | D | A | A | A | A |
| Tactile Sensation | A | A | A | A | A | A |
| Glossiness | A | A | A | A | A | A |
| Flame Retardancy | A | A | D | D | D | D |

From the results in Tables 1 to 3, the fiber bundle for artificial hair of the Examples have good combing property, tactile sensation and glossiness similar to human hair, and are excellent in curl setting characteristics and flame retardancy, and can be suitably used for head decoration products.

1. A fiber bundle for artificial hair comprising 20 to 90 parts by mass of a polyester fiber and 10 to 80 parts by mass of a polyamide fiber, wherein
the polyester fiber contains a polyester resin (A), a flame retardant (C1) and an auxiliary flame retardant (D1), and
the polyamide fiber contains a polyamide resin (B), a flame retardant (C2) and an auxiliary flame retardant (D2).

2. The fiber bundle for artificial hair of claim 1, wherein the polyamide fiber contains 3 to 30 parts by mass of the flame retardant (C2) and 0.3 to 10 parts by mass of the auxiliary flame retardant (D2) based on 100 parts by mass of the polyamide resin (B).

3. The fiber bundle for artificial hair of claim 1, wherein the polyester fiber contains 3 to 30 parts by mass of the flame retardant (C1) and 0.3 to 10 parts by mass of the auxiliary flame retardant (D1) based on 100 parts by mass of the polyester resin (A).

4. The fiber bundle for artificial hair of claim 1, wherein the polyamide resin (B) has a weight average molecular weight Mw of 65,000 to 150,000.

5. The fiber bundle for artificial hair of claim 1, wherein the polyamide resin (B) is at least one selected from the group consisting of polyamide 6 and polyamide 66.

6. The fiber bundle for artificial hair of claim 1, wherein the flame retardant (C1) of the polyester fiber and the flame retardant (C2) of the polyamide fiber are brominated-based flame retardants.

7. The fiber bundle for artificial hair of claim 6, wherein each of the brominated-based flame retardants is at least one selected from the group consisting of a brominated phenol condensate, a brominated polystyrene-based flame retardant, a brominated benzyl acrylate-based flame retardant, a brominated epoxy-based flame retardant, a brominated phenoxy-based flame retardant, a brominated polycarbonate-based flame retardant and a bromine-containing triazine-based compound.

8. The fiber bundle for artificial hair of claim 1, wherein the auxiliary flame retardant (D2) of the polyamide fiber is at least one selected from the group consisting of antimony trioxide, antimony tetroxide, antimony pentoxide, sodium antimonate, zinc borate, and zinc stannate.

9. The fiber bundle for artificial hair of claim 1, wherein the auxiliary flame retardant (D2) of the polyamide fiber has an average particle size of 1 to 10 μm.

10. The fiber bundle for artificial hair of claim 1, the polyester resin (A) has a melt viscosity of 80 to 300 Pa·s.

11. The fiber bundle for artificial hair of claim 1, a resin composition constituting the polyamide fiber has a melt viscosity of 20 to 200 Pa·S.
